(19) United States
(12) Patent Application Publication
(10) Pub. No.: US 2005/0064853 A1
(43) Pub. Date: Mar. 24, 2005

(54) Unified telephone handset for personal communications based on wireline and wireless network convergence

(75) Inventor: Assad Radpour, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/668,687

(22) Filed: Sep. 23, 2003

(51) Int. Cl. H04Q 7/20

(52) U.S. Cl. 455/414.4

(57) ABSTRACT

In a particular embodiment, the disclosure is directed to a mobile communication device including an antenna, mobile telephony circuitry, a service request module and a voice conversion module. The mobile telephony circuitry is configured to communicate with a mobile telephony network using a mobile communication protocol. The mobile telephony circuitry is coupled to the antenna. The service request module is configured to determine the proximity to a wireless network base station using a wireless data network protocol. The service request module is configured to establish a communication path via the wireless data network protocol. The voice conversion module is configured to convert voice communication to packet data to be communicated using the wireless data network protocol to the wireless network base station.

### FIELD OF THE DISCLOSURE

The present disclosure relates generally to unified telephone handsets for personal communications based on wireline and wireless network convergence.

### BACKGROUND

In an increasingly mobile society, mobile telephones and telecommunications devices have become ubiquitous. Cell phones and other mobile telecommunications devices offer the ability to be in contact or reachable at all times. However, users of cell phones typically have more than one phone number at which they may be reached. For example, cellular telephone users may also have a landline phone number for their home or office.

In a typical situation, a caller may attempt one of several numbers in an attempt to reach an individual. For example, a caller may first call a home number and then a cell number or office number. This added effort wastes time and telephony resources.

To save time many callers will call a cell phone or mobile telecommunications device number first. But, receiving a call on a cell phone may be more expensive than receiving a phone call on the user's landline phone. Furthermore, the cellular coverage, in general, may not be adequate within buildings for high-quality carrier-grade voice.

Some service providers have implemented a service in which different numbers provided by the user are attempted until the user answers. However, callers may become frustrated while waiting through several attempts to connect to the user through different numbers. As such, an improved personal communications method and system would be desirable.

### BRIEF DESCRIPTION OF THE DRAWINGS

FIG. 1 depicts an exemplary embodiment of a call management system.

FIG. 2 depicts an exemplary embodiment of a call management device.

FIG. 3 illustrates an exemplary communication flow.

FIG. 4 depicts an exemplary method of call management.

FIG. 5 depicts an exemplary mobile communication device.

FIG. 6 depicts an exemplary base station device.

FIG. 7 depicts an exemplary method of call management.

The use of the same reference symbols in different drawings indicates similar or identical items.

### DESCRIPTION OF THE PREFERRED EMBODIMENT(S)

The present disclosure is generally directed to the provision of an integrated wireless and wireline communications system and methods thereof. The system and methods disclosed herein offer users convenience and flexibility by providing location based routing to an alternate telephone destination such as a landline (wireline) telephone automatically by the mobile telephone handset or related device being brought to the perimeters of an alternate telephone destination. The mobile telephone handset may also communicate utilizing a wireless data network associated with the alternate telephone destination, such as communicating Voice-over-IP data. In addition, other conventional service-rich features, such as distinctive ring, caller identification/privacy management, and a common voicemail service for a user's wireless and wireline telephones are also possible when utilizing the system and methods disclosed herein.

In a particular embodiment, the disclosure is directed to a mobile communication device including an antenna, mobile telephony circuitry, a service request module and a voice conversion module. The mobile telephony circuitry is configured to communicate with a mobile telephony network using a mobile communication protocol. The mobile telephony circuitry is coupled to the antenna. The service request module is configured to determine the presence of the mobile communications device in the proximity to a wireless network base station using a wireless data network protocol. The service request module is configured to establish a communication path via the wireless data network protocol. The voice conversion module is configured to convert analog voice communication to packets, such as Voice-over Internet Protocol (VoIP) packets, configured for communication using the wireless data network protocol.

In another exemplary embodiment, the disclosure is directed to a cordless telephony station including a network interface, a telephony module, wireless communications circuitry, an administration module, and a modem. The network interface is configured to interface with a public switched telephone network (PSTN). The telephony module is coupled to the network interface. The telephony module is configured to convert analog telephone signals to digital network based signals. The wireless communications circuitry is coupled to the telephony module. The wireless communications circuitry is configured to communicate the digital network based signals to a mobile device using a wireless network protocol. The administration module is coupled to the wireless communications circuitry and is configured to detect the presence of the mobile device within a proximate coverage area. The modem is coupled to the network interface. The administration module is configured to communicate a call forwarding message via the modem to a remote registration system associated with the mobile device.

In a further exemplary embodiment, the disclosure is directed to a method of call management. The method includes detecting a mobile communication device via a wireless data network protocol, establishing a communication path with the mobile communication device using the wireless data network protocol and sending a call control message to a remote call management module associated with the mobile telecommunications network and associated with the mobile communication device. The mobile communication device is configured to communicate with a mobile telecommunications network and is configured to communicate with a wireless data network using a wireless data network protocol. The call control message is sent via the public switched telephone network.

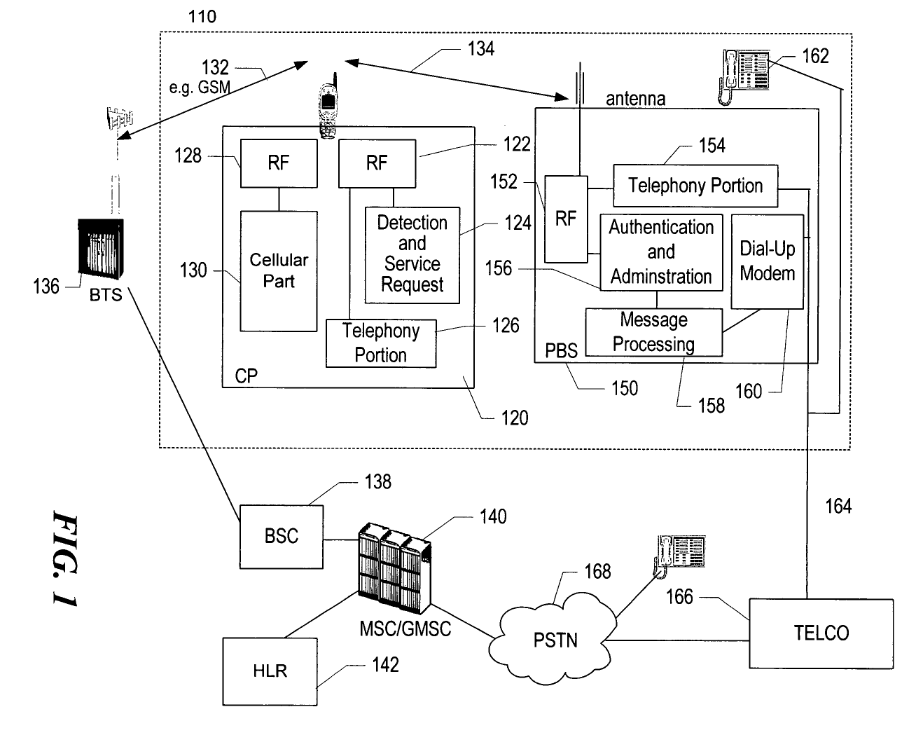

Specifically, FIG. 1 illustrates, in block diagram form, an embodiment of an integrated wireless/wireline communication system. The integrated wireless/wireline communications system includes a handset 120 and a personal base station 150 within a wireless detection area 110. The system coverage area 110 may be provided by a wireless base station or an access point 150 that provides a wireless data network to incorporate the handset 120 with an authenticated two-way communication. The communication interface between the handset 120 and the access point 150 may be over wireless data protocols, such as the IEEE 802.11x or Bluetooth®, using the unlicensed frequency bands.

The system further includes a wireless telephony switch 140 such as that used in a wide-area cellular network, which establishes communication with an alternate telephone destination 162 via an intermediary switch typically located within a telephone service provider central office 166. The home personal base station (PBS) 150 communicates with the handset 120 via a radio transmission signal 134. The wireless switch 140 communicates with a mobile cellular telephone portion of the handset 120 via a radio signal 132. For example, the signal 132 is transferred between the handset 120 and a base transceiver station (BTS) 136. The BTS 136 communicates with a base station controller (BSC) 138. The BSC 138 communicates with the mobile switching center (MSC) 140. The MSC 140 has an associated home location registry (HLR) 142.

In an embodiment, the alternate telephone destination 162 is a telephone number associated with a landline telephone associated with the home base station 150. The terms perimeter and proximity area as used herein identify the physical radio frequency coverage area within which the handset 120 can communicate with the base station 150.

In one embodiment, the radio transmission signal 134 from the home base station transmitter 150 utilizes a wireless data protocol. The wireless data protocol may be the IEEE 802.11x standard wireless protocol, the Bluetooth standard protocol, or other wireless data protocols employed in the telecommunications industry. The transmission signal 134 may also utilize security standards, such as wired equivalent privacy (WEP). The home base station 150 may use the wireless data protocol to send Voive-over-IP (VoIP) data packets and may ensure quality of service (QoS) by giving higher priority to VoIP data packets. In this manner, the home base station 150 may perform like a cordless telephony system.

In one embodiment, the transmission signal 132 from the handset 120 utilizes a mobile communication protocol. The wireless data protocol may be the Global System for Mobile communications (GSM), General Packet Radio Service (GPRS), Universal Mobile Telecommunications System (UMTS), or CDMA2000/CDMAOne cellular wireless telephony protocols, or other suitable wireless data protocols employed in the telecommunications industry.

In one embodiment, the personal communication handset 120 has a first transceiver 122 using a wireless data network protocol, to facilitate two-way telephone conversations, user presence detection, authentication, and session establishment and maintenance; and a second transceiver 128 using a mobile communication protocol, to facilitate two-way telephone conversation in a wide-area mobile cellular communications environment. The handset 120 may, for example, have a detection and service request module 124 coupled to the first transceiver 122. The detection and service request module 124 may provide for wireless data network detection, authentication, and session establishment. The handset 120 may also have a telephony module 126 coupled to the transceiver 122. The telephony module 126 may convert voice communications to packets configured for transmission via a wireless data network handling Voice-over-IP packets. The handset may also, for example, have mobile communication circuitry 130 coupled to the transceiver 128 for voice and data communications via a mobile communications network. The handset 120 may also include a power supply controller that may selectively switch between the mobile communication circuitry 130 and the personal base station circuitry 126/124 to conserve power when out of the range of the wide area mobile communications network and in the presence of the wireless data network, or vise versa. The power supply may be automatically or manually switched.

The personal base station 150 may include a radio frequency transceiver 152 for communication using a wireless data network protocol, such as IEEE 802.11 or Bluetooth®. The base station 150 may further include a telephony module 154, an authentication and administration module 156, a message processing module 158, and a modem 160. The telephony module 154 may be coupled to the transceiver 152 and convert voice communication between an analog signal and a digital packet based signal. The digital signal may, for example, be a Voice-over-IP signal for communication via the wireless data network. The authentication and administration module 156 may be coupled to the transceiver 152 and act to provide user presence detection, authentication, and session establishment and maintenance between the base station 150 and the wireless handset 120. The authentication module 156 may also act in conjunction with the message processing module 158 to send a call control message via the PSTN 168 to the HLR 142 associated with the mobile communication network, in regards to the handset 120. For example, a modem 160 may be used to call a system associated with the MSC 140 and HLR 142 to establish or cancel call forwarding.

In one exemplary embodiment, when the handset 120 enters a wireless data network coverage area, it detects the wireless network and establishes communication with the base station 150. The base station 150 may accept the handset 120 and authenticates and authorizes the handset 120 to communicate with the wireless network. The authentication and administration module 156 facilitates the sending of a call control message to establish redirection of cellular calls addressed to the handset 120 via the mobile communication network. The calls may be redirected to the PSTN destination 162 associated with the base station 150. In another exemplary embodiment, the handset 120 may exit the coverage area of the wireless data network and the base station 150 may send a call control message canceling a previously established call forwarding. The communication between the base station 150 and HLR 142 may be established through dial-up modems at the wireless network site and corresponding modem pools at MSC/GMSC 140 using industry standards such as v.90. The users may also be authenticated through servers at the modem pool using protocols such as the RADIUS (Remote Authentication Dial In User Service).

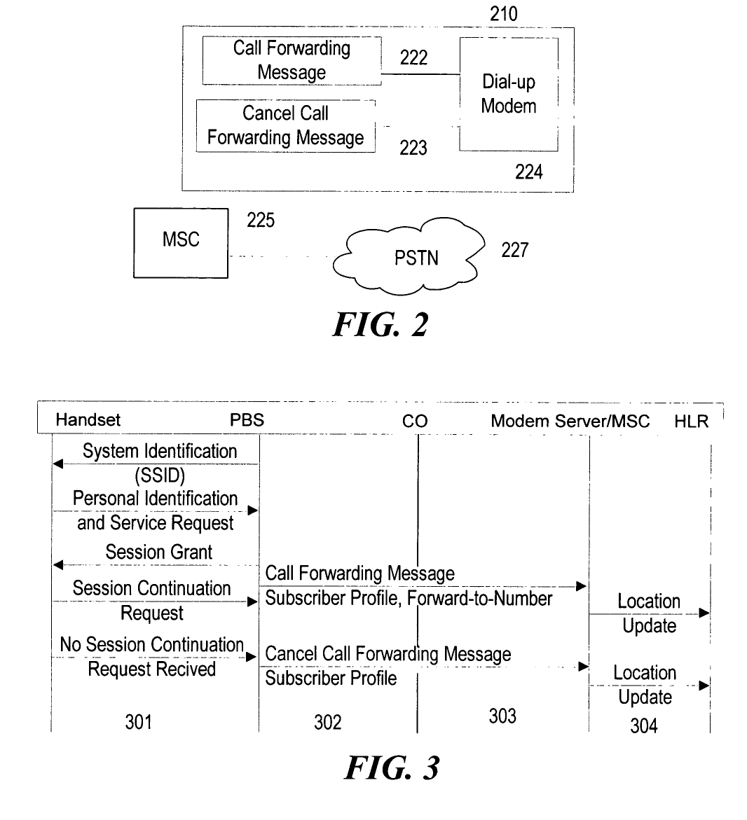

FIG. 2 is a block diagram illustrating a communications interface 210. Communications interface 210 may be located inside the home base station 150. Communications interface 210 comprises a first control module, call forwarding module 222, and a second control module, cancel call forwarding module 223. Both of the modules 222, 223 send respective instruction streams to a transmitter 224. Transmitter 224 transmits the instruction messages using standard signaling protocols such as the PPP (Point-to-Point Protocol).

Generally, the call forwarding and cancel call forwarding messages communicated between the handset 120 and the wireless switch 140 comprise a data message that can be routed through the wireline network using a dial-up modem 160 or a broadband (e.g. DSL) access, or through the cellular wireless network using SMS, GPRS, EDGE, or UMTS protocols.

Call forwarding module 222 receives a request to forward a call forwarding message associated with a mobile subscriber number along with a forward-to number, to a wide-area mobile wireless network switch, such as MSC 225. Cancel call forwarding module 223 receives a request to forward a cancel call forwarding message associated with a mobile subscriber number to the wide-area mobile wireless network switch MSC 225. The request may be received as part of an automatic feature or as part of a manual user response. For example, calls may be forwarded when the handset is in communication with the wireless data network, and call forwarding may be canceled when the status of the handset in the wireless network changes, such as when the handset loses contact with the wireless network or fails to send an expected signal.

FIG. 3 is a sequence flow diagram illustrating feature activation for an integrated wireless and wireline communication system. The example provided in FIG. 3 illustrates a system containing a handset, a modem server, a mobile switching center (MSC), and a home location register (HLR). Communication path 301 indicates communication between the handset and the PBS. Communication path 302 indicates communication between the Personal Base Station (PBS) and the Central Office (CO). Communication path 303 illustrates communication between the CO and the MSC and communication path 304 depicts communication between the MSC and the HLR.

As shown in communication path 301, when brought into the personal base station (PBS) coverage area, the user handset detects a pre-selected PBS. The handset then transmits its identification data and requests to be authenticated. The PBS confirms authentication by sending a session initiation message to the handset. The session will be held as long as the handset sends, at pre-determined intervals, a session continuation request message to the PBS.

As shown in communication path 302, the PBS requests the local telephone switch to establish a dial-up connection to the MSC, and after connection is made, it sends a call forwarding message with the associated mobile telephone number and a forward-to number to the MSC.

As shown in communication path 303, the local telephone switch establishes a dial-up connection to a modem server at the MSC. As shown in communication path 304, after authenticating the mobile number, through the MSC, the modem server sends an Activate Feature Directive or location update using SS7 TCAP to the HLR. The HLR marks the mobile telephone number for forwarding to the ‘forwarded to’ number associated with the unified handset (the mobile communications device).

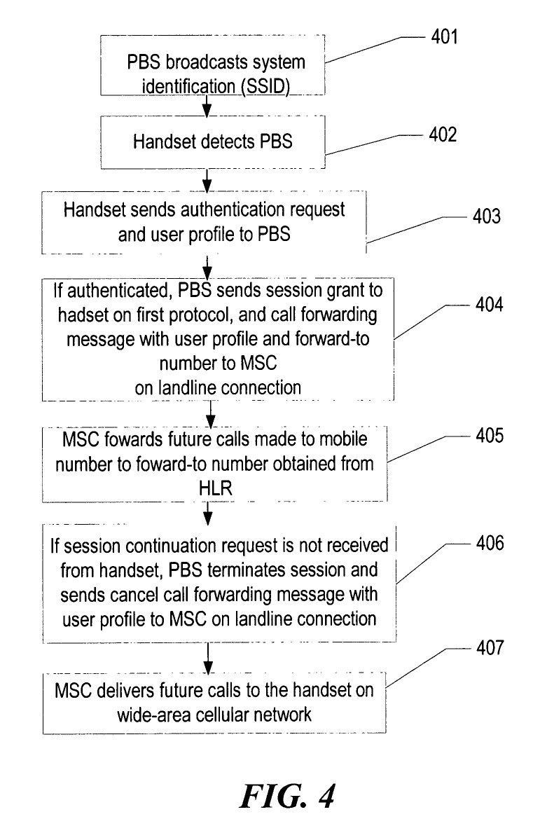

FIG. 4 is a flow diagram of an exemplary method for integrating wireless communications devices and alternate communication devices.

As shown at step 402, a wireless handset detects a wireless access point signal containing an access point or home portal identification. In a particular embodiment, the access point is proximal to a wireless home personal base station (PBS). The first wireless connection may utilize the IEEE 802.11 or Bluetooth wireless standards.

As shown at step 403 the handset transmits a request for authentication along with its profile data. As shown at step 404, the PBS, after authenticating the handset, sends a session initiation confirmation to the handset, and a call forward message to the MSC to forward voice communication originally destined for the mobile subscriber to an alternate communication device.

The request to the wireless switch (MSC) may be made using a tunneling protocol over a wired connection, such as a broadband connection or a dial up modem. The alternate communication device may be a wireline (landline) telephone destination with a base station located proximal to the wireless communications handset. In a particular embodiment, the wireless mobile communication handset receives a wireless communication transmitted in accordance with a different protocol than the wide-area mobile communication protocol. In particular embodiments, the wireless mobile communication device may communicate with the wireless switch via non-voice data messaging, such as the Short Message Service (SMS) protocol.

Incoming calls destined for the wireless mobile communication device are forwarded to the alternate communication device until a determination, as shown at step 405, has been made as to withdraw the request for call forwarding to the alternate communication device.

As shown at step 406, the PBS sends a cancel call forwarding message to the MSC if a session continuation request which is expected by the PBS to be received at a pre-determined rate is not received.

In a particular embodiment, the call forward request is withdrawn when the wireless mobile communication device no longer receives the session continuation request, such as when the mobile phone is moved outside the range of the access point or the handset is turned off. In another embodiment, the user is queried upon turn-off as to whether the session should be kept and whether the call forwarding should be cancelled. In another embodiment, the call forwarding request is withdrawn in response to a user action. A user action can be a key sequence entered using the keypad of the wireless mobile communication device or a voice request.

As shown at step 407, since call forwarding has been cancelled incoming communication are again directed to the wireless mobile communication handset through the wide-area mobile cellular network.

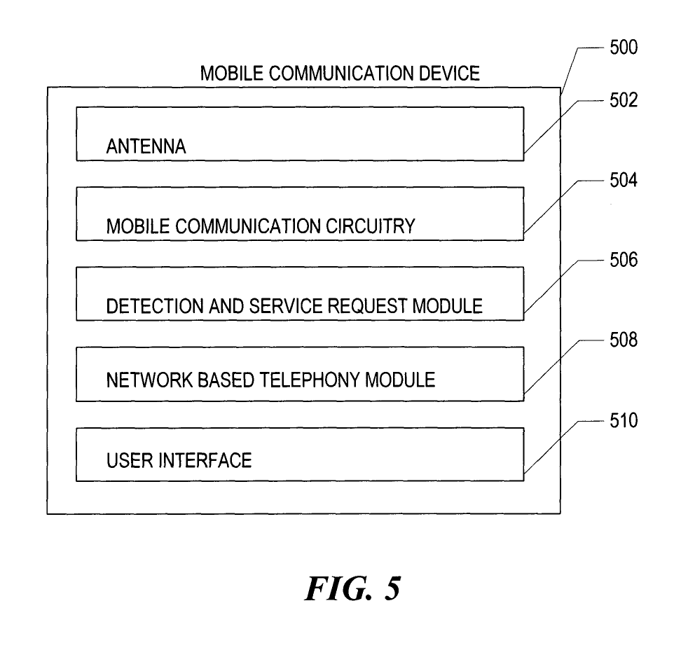

FIG. 5 depicts an exemplary embodiment of a mobile communication device. The mobile communication device 500 includes an antenna 502, mobile communications circuitry 504, detection and service request module 506, network based telephony module 508 and a user interface 510. The mobile communications circuitry 504 is coupled to the antenna 502. The mobile communications circuitry 504 is configured to communicate with a mobile communications network. The mobile communications network may, for example, be a cellular or PCS network using standards such as GSM, UMTS, or CDMA2000.

The detection and service request module 506 is configured to detect a wireless data network. The wireless network may utilize various wireless data network protocols such as IEEE 802.11x or Bluetooth®. The detection and service request module 506 may establish a communication path with the wireless data network. For example, the detection and service request module 506 may communicate with the wireless data network to establish a network address, authenticate the device, and establish security protocols. For example, the detection and service request module 506 may establish communication with an IEEE 802.11 wireless data network by authenticating its identification, providing a password, and establishing an encryption key using a protocol, such as wired equivalent privacy (WEP). In one embodiment, the services provided by the wireless data network is sustained when a repetitive “session continuation request” signal is received from the mobile communications device at a pre-determined periodicity or periodic rate.

The mobile communication device 500, may also include a network based telephony module 508. The network based telephony module 508 may convert voice communications to network based packets for transmission over a network utilizing a packet protocol such as the Internet Protocol (IP). The network based telephony module 508 may be configured to use standards such as SIP (Session Initiation Protocol) for Voice-over-IP (VoIP) signalling. The network based packets may be transmitted over the wireless data network. The telephony module 508 may also be configured to receive packets via the wireless data network and convert these packets to voice communications signals.

The mobile communication device 500 may also include a user interface 510. In an exemplary embodiment where the mobile device 500 is a phone, the user interface may, for example, include a screen and a number pad. In an exemplary embodiment of a personal digital assistant (PDA) that has mobile communications capabilities, the user interface may include a touch screen.

By including both a wireless data network based system and a mobile communications based system, the mobile communications device 500 may alternately or selectively communicate with a wide-area mobile communications network or a short range wireless data network. The mobile communication device 500 may also notify the wireless data network of its presence, permitting communications to be transmitted through the wireless data network. In addition, a base station associated with the wireless data network may detect the presence of the mobile communication device 500 and manipulate call forwarding features associated with the wireless communication device 500 by sending a call control message to a registration system such as a home location registry (HLR).

Call forwarding functionality and wireless data network based communication may be established automatically. Alternately, the user may be prompted to permit call forwarding or to selectively communicate using the wireless data network instead of the mobile communication network. For example, upon entering into the range of the wireless data network, and after detecting and being authenticated by the wireless data network, the user may be prompted for permission to place calls utilizing the wireless data network instead of the mobile communications network. In another exemplary embodiment, when a user attempts to place a call, the user may be prompted to select between the mobile communications network and the wireless data network.

The mobile communication device 500 may also include power circuitry that selectively connects to one or both of the communications circuitries. For example, a user may turn off the mobile communication circuitry while leaving the wireless data network communication circuitry on.

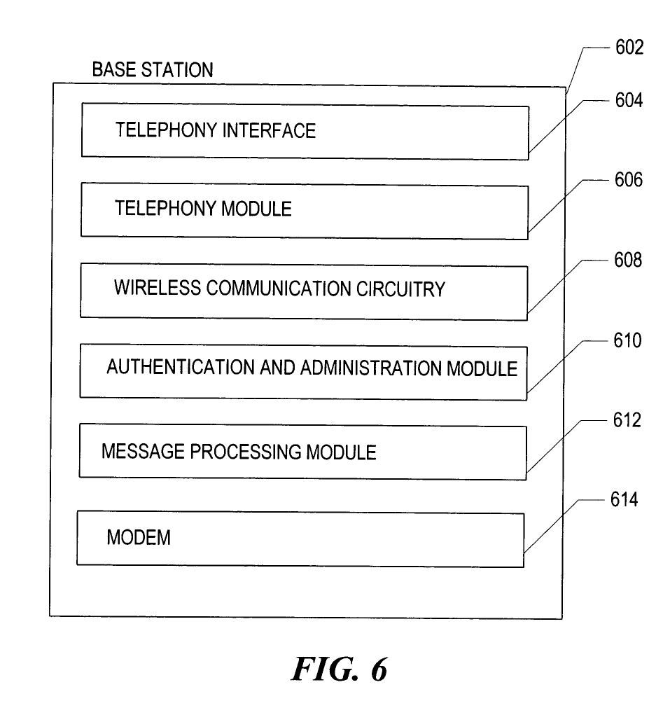

FIG. 6 depicts an exemplary embodiment of a base station 602. The base station includes a telephony interface 604, a telephony module 606, a wireless communications circuitry 608, an authentication and administration module 610, a message processing module 612 and a modem 614. The telephony interface 604 is configured to couple with a public switched telephone network (PSTN) via a plain old telephone service (POTS). The telephony module 606 is configured to convert the communications between the POTS and a network based system. For example, the telephony module 606 may act to convert communication between an analog voice communication system and a packet voice or Voice-over-IP system. The telephony module 606 is coupled to a wireless communication circuitry 608. For example, the telephony module 606 may send and receive Voice-over-IP communications and SIP signaling via a wireless data network associated with the wireless communication circuitry 608. The authentication and administration module 610 is coupled to a wireless communication circuitry 608. For example, the authentication and administration module 610 may send and receive data via a wireless data network associated with the wireless communication circuitry 608.

The wireless communication circuitry 608 may communicate with a wireless data network using standards such as IEEE 802.11 and Bluetooth®. The authentication and administration module 610 is coupled to the wireless communication circuitry 608 and acts to authenticate and establish communications with devices on the wireless data network. For example, the authentication and administration module 610 may authenticate devices, exchange logins and passwords, establish security protocols, such as WEP, and provide network addresses. The administration module 610 may also detect the presence of a mobile communication device within a proximity area. Once the mobile communication device is identified, the administration module 610 may send a call control message to a registration system, such as a home location registry (HLR), associated with the mobile communication device. The call control message may for example establish or cancel call forwarding. The authentication and administration module 610 may access a message processing module 612 to send the call control message. The message processing module 612 may be coupled to a modem 614 which may establish a call through the POTS system and send the message to the HLR.

The base station 602 may act to manage call forwarding features associated with the mobile communication device. For example, when the mobile communication device establishes a network presence and is authenticated, the base station 602 may facilitate the forwarding of calls addressed to the mobile communication device to be redirected to the PSTN address associated with the base station. In one exemplary embodiment, when the mobile communication device exits the wireless data network coverage area or is no longer in communication with the wireless data network, the base station may cancel the call forwarding associated with the mobile communication device. In addition, the base station may establish voice communications with the mobile communications device, using such standards as SIP for packet voice or Voice-over-IP. In this manner, the mobile communications device may be used as both a conventional mobile cellular telephone and a personal wireless telephone similar in function to the conventional cordless telephone.

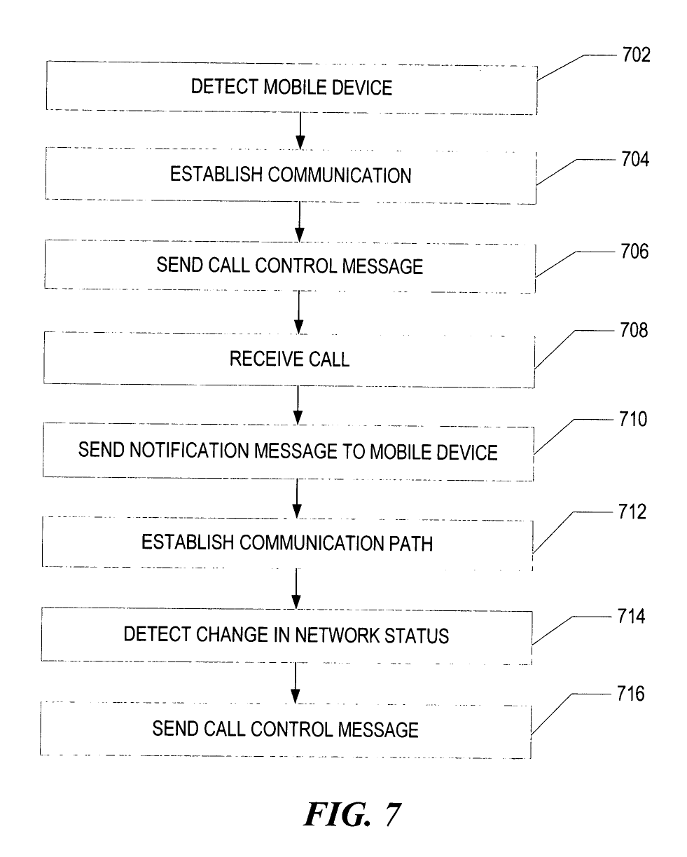

FIG. 7 illustrates an exemplary method for call management. When the mobile communication device enters a region covered by a wireless network, the mobile communications device may detect the presence of the wireless network, as shown at step 702. The wireless data network may then establish communication with the mobile communication device using a wireless data network protocol, as shown at step 704. A call control message may be sent to a registration system, such as a home location registry (HLR) associated with the mobile communications device, as shown at step 706. The call control message may establish call forwarding to a PSTN network address associated with a base station. The base station may then receive calls as shown at step 708. Notification of these calls may be sent to the mobile communication device, as shown at step 710, and a communications path may be established, as shown at step 712. For example, Voice-over-IP communications may be established between a mobile communications device and a base station. The base station may then convert these communications for transmission to and via a POTS system.

If the network status of the mobile communication device changes, the base station may detect the change, for example as a result of not receiving the session continuation request signal, as shown at step 714. In one embodiment, the session continuation request signal may not be received when the mobile communications device is out of the range of the wireless data network, or when the mobile communications device is turned off, or when the user has otherwise selected to disable its transmission. For example, the mobile communications device may exit a region covered by the wireless data network. The base station may detect the change in the status and send another control message as shown at step 716. For example, the base station may send a call control message to a registration system associated with the mobile communication device canceling call forwarding.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A mobile communication device comprising:
an antenna;
mobile telephony circuitry configured to communicate with a mobile telephony network using a mobile communication protocol, the mobile telephony circuitry coupled to the antenna;
a service request module configured to determine proximity to a wireless network base station using a wireless data network protocol and configured to establish a communication path via the wireless data network protocol; and
a voice conversion module configured to convert between voice communication and data packets to be communicated using the wireless data network protocol with the wireless network base station.

2. The mobile communication device of claim 1, wherein the wireless network base station is configured to send a call control message to a registration system associated with the mobile telephony network in regards to the proximity of the mobile communication device and the wireless network base station.

3. The mobile communication device of claim 2, wherein the call control message establishes redirection of calls addressing the mobile communication device via the mobile telephony network to a public switched telephone network address associated with the wireless network base station.

4. The mobile communication device of claim 2, wherein the call control message cancels redirection of calls addressing the mobile communication device.

5. The mobile communication device of claim 1, wherein the wireless data network protocol is IEEE 802.11.

6. The mobile communication device of claim 1, wherein the wireless data network protocol is Bluetooth.

7. The mobile communication device of claim 1, wherein the mobile communication protocol is associated with at least one of Global System for Mobile communications (GSM), General Packet Radio Service (GPRS), Universal Mobile Telecommunications System (UMTS), and CDMA2000/CDMAOne.

8. The mobile communication device of claim 1, wherein the voice communication is communicated as Voice-over-IP using the data packets.

9. The mobile communication device of claim 1, further comprising power circuitry selectively providing power to the mobile telephony circuitry.

10. A cordless telephony station comprising:
a network interface configured to interface with a public switched telephone network;
a telephony module coupled to the network interface, the telephony module configured to convert analog telephone signals to digital network based signals;
wireless communication circuitry coupled to the telephony module, the wireless communication circuitry configured to communicate the digital network based signals to a mobile device using a wireless network protocol;
an administration module coupled to the wireless communication circuitry and configured to accept the presence of the mobile device within a proximate coverage area; and
a modem coupled to the network interface, wherein the administration module is configured to communicate a call forwarding message via the modem to a remote registration system associated with the mobile device.

11. The cordless telephony station of claim 10, wherein the wireless network protocol is IEEE 802.11.

12. The cordless telephony station of claim 10, wherein the wireless network protocol is Bluetooth.

13. The cordless telephony station of claim 10, wherein the digital network based signals are Voice over IP signals.

14. The cordless telephony station of claim 10, wherein the network interface is configured to connect to a plain old telephone service (POTS) provided by the public switched telephone network.

15. The cordless telephony station of claim 10, wherein the call forwarding message establishes redirection of calls to a public switched telephone network address associated with the cordless telephony system.

16. The cordless telephony station of claim 15, wherein the administration module is configured to communicate the call forwarding message in response to accepting the presence of the mobile device within the proximity coverage area.

17. The cordless telephony station of claim 10, wherein presence of the mobile device is detected by communicating a message using the wireless network protocol.

18. The cordless telephony station of claim 10, wherein the call forwarding message cancels the redirection of calls addressing the mobile device.

19. The cordless telephony station of claim 18, wherein the administration module is configured to communicate the call forwarding message upon a change in location of the mobile device with respect to the proximity coverage area.

20. The cordless telephony station of claim 10, wherein the registration system is a home location registry.

21. A method of call management, the method comprising:
detecting a mobile communication device via a wireless data network protocol, the mobile communication device configured to communicate with a mobile telecommunication network and configured to communicate with a wireless data network using the wireless data network protocol;
establishing a communication path with the mobile communication device using the wireless data network; and
sending a call control message to a remote call management module via a public switched telephone network, the remote call management module associated with the mobile telecommunication network and associated with the mobile communication device.

22. The method of claim 21, wherein the wireless data network protocol is IEEE 802.11.

23. The method of claim 21, wherein the wireless data network protocol is Bluetooth®.

24. The method of claim 21, wherein the mobile telecommunication network is associated with Global System for Mobile communications (GSM), General Packet Radio Service (GPRS), Universal Mobile Telecommunications System (UMTS), or CDMA2000/CDMAOne.

25. The method of claim 21, wherein sending the call control message is performed using a modem connected to a plain old telephone service (POTS).

26. The method of claim 21, further comprising:
receiving a telephone call including analog voice communication signals;
converting the analog voice communication signals to digital network-based communication messages; and
communicating the digital network-based communication messages to the mobile communication device via the wireless data network.
